(19) United States
(12) Patent Application Publication
(10) Pub. No.: US 2018/0159882 A1
(43) Pub. Date: Jun. 7, 2018

(54) SYSTEM AND METHODS TO PREVENT SECURITY BREACHING BY AUTHORIZED USERS IN A CLOUD ENVIRONMENT

(71) Applicant: OCUCLOUD LTD., Ramat Gan (IL)

(72) Inventors: GAVIN BRILL, RAMAT GAN (IL); GIL FEFER, GEDERA (IL)

(21) Appl. No.: 15/826,785

(22) Filed: Nov. 30, 2017

Related U.S. Application Data
(60) Provisional application No. 62/428,566, filed on Dec. 1, 2016.

(51) Int. Cl. H04L 29/06; H04L 9/14

(52) U.S. Cl. CPC H04L 63/1425; H04L 9/14; H04L 63/166; H04L 63/0428; H04L 2463/082; H04L 63/0861; H04L 63/0218; H04L 63/0281; H04L 63/0838

(57) ABSTRACT

A system to facilitate preventing security breach of internal organizational resources by authorized system users. Resource access analysis prevents breaching sensitive organizational information stored in a cloud infrastructure environment. A virtual machine (VM) breach-detection proxy controls and monitors activities of a system user. A virtual machine (VM) breach-detection portal provides system administration of organizational data sensitive regions. The system interfaces with the cloud environment to retrieve log files and provides indexed video session representations of system user activities accessing data sensitive region.

### CROSS-REFERENCE TO RELATED APPLICATIONS

This application claims the benefit of priority from U.S. Provisional Patent Application No. 62/428,566, filed Dec. 1, 2016, the contents of which are incorporated by reference in their entirety.

### FIELD

The disclosure herein relates to system and methods for preventing security breach of internal organizational resources by authorized system users such as internal employees, external employees, vendors, contractors, partners, customers and the like, all of which may have access to specific sensitive data resources of the organization.

### BACKGROUND

Cloud computing, associated with the use of highly scaled, shared, and automated IT platforms is growing rapidly and has become a key part of the ongoing IT strategy of organization throughout the world. An important concern regards access to internal organization resources stored in databases or repositories, by unauthorized people, however such data may also be accessed within internal infrastructure of the organization by people having the authority to reach the sensitive information and resources. Yet, multiple system users spanning employees, vendors and partners require quick, safe and seamless access to cloud services regardless of where they are located.

As more systems, applications and data are moved into cloud provider environments, loss of data, stolen information or unauthorized use of data is likely to become more common, raising the need for users and organizations to take measures such that the data is kept safe.

It should be appreciated that large institutions often build and manage private-cloud environments internally (and, in some cases, procure access to external public clouds) for basic infrastructure services, development platforms, and a whole set of applications. Smaller businesses primarily buy in public-cloud offerings, as they generally lack the scale to set up their own clouds.

Thus, as attractive as cloud environments can be, they also come with new types of risks. Traditional measures of using a password authentication system to enable access to stored sensitive data by authorized users are not sufficient to provide the level of security required, does not provide sufficient protection against ill-mannered behavior of apparently trusted employee/partners/vendors/customers/suppliers and the like.

Thus, the need remains therefore, for the protection of cloud-based data resources against malicious activities of non-authorized people, but no less against ill-mannered behavior of trusted people having formal organization authorization to access the sensitive resources.

The invention described herein addresses the above-described needs by introducing the resource protection system.

### SUMMARY

The main value proposition of a resource protection system as described herein is the ability to prevent security breaches by users having authorization to access internal organizational resources. The system is operable to provide video recording visibility for the organizational resources, such as general organization information, infrastructure, applications, specific data and the like, stored in the cloud, irrespective of the endpoint accessing devices.

The resource protection system may also provide a tool set for the security teams to better understand security threats happening within cloud services, by insiders, and correlate those events with activities across traditional IT infrastructures.

According to various embodiments of the currently disclosed subject matter, there is provided a resource protection system operable to perform resource access analysis to prevent breaching sensitive organizational information stored in a cloud infrastructure environment. The resource protection system, comprising: a virtual machine (VM) breach-detection proxy operable to perform automated control and monitoring of at least one activity of at least one system user using a communication device and accessing at least one data sensitive region; and a virtual machine (VM) breach-detection portal operable to provide system administration of the at least one data sensitive region;

wherein the resource protection system is operable to interface with the cloud infrastructure or environment to retrieve at least one log file associated with at least one system user, the cloud infrastructure environment comprises at least one server and a set of cloud applications; and wherein the resource protection system is operable to provide at least one video session indexed representation to allow visibility of at least one system user activity accessing the at least one data sensitive region, the indexed representation uses at least one log file.

Where appropriate, each of the virtual machines (VM) automatically installs upon loading.

Where appropriate, proxy is operable to provide a secured communication channel for all communications between the communicating device and the cloud infrastructure environment via said virtual machine (VM) breach-detection proxy. The secured communication channel comprises using a dedicated sub-domain and an associated security certificate, such that at least one system user can communicate securely via the communicating device with the virtual machine (VM) breach-detection proxy.

Additionally, the secured communication channel further comprising an identical set of encryption keys for the communication device, the breach-detection proxy and the cloud infrastructure environment is achieved by handling all transport layer security (TLS) protocol communications by the virtual machine (VM) breach-detection proxy. Accordingly, the virtual machine (VM) breach-detection proxy is configured to record at least one http packet when the secured communication channel is being established.

As appropriate, the resource protection system, is further operable to configure the cloud infrastructure environment to direct communication traffic via the virtual machine (VM) breach-detection proxy. Further, the virtual machine (VM) breach-detection proxy is operable to inject a recording code into at least one application page received by the client to allow recording and tracking at least one system user activity.

The virtual machine (VM) breach-detection proxy further comprises a user plugin module, the user plugin module is operable to execute instructions and communicate with at least one system user plugin associated with at least one system user via a dedicated API (Application Programming Interface). Further, the user plugin module is operable to enable selecting at least one system user for generating at least one video session indexed representation.

As appropriate, at least one data sensitive region is configured by a system administrator.

Additionally, the machine (VM) breach-detection proxy comprises an identity access management module to control automatically an initial login credential associated with at least one system user, the initial login credential is configured to allow initial authorized access to at least one data sensitive region. Variously, the initial login credential is selected from at least one of a group consisting of: a user name and password, one-time password (OTP), a fingerprint, a face recognition, biometrics or combinations thereof. Accordingly, the identity access management module is operable to change the initial login credential with a second login credential comprising a random value. Further, the second login credential serves as the entry code to the cloud infrastructure environment. Moreover, the identity access management module is operable in a non-intrusive manner.

According to another aspect of the presently disclosed subject matter, there is provided a method for use in a resource protection system to perform resource security analysis in an improved manner, the system comprises a virtual machine (VM) breach-detection proxy in communication with a cloud infrastructure environment comprising at least one cloud server and a set of cloud applications accessible to at least one system user using a communicating device, and a virtual machine (VM) breach-detection portal, the method comprising the steps of: setting a secured communication channel with a cloud infrastructure environment; retrieving a set of raw log data information associated with at least one system user from at least one cloud server; recording at least one system user activity; and reconstructing the set of raw log data information and the recorded at least one user activity into a video representation session.

Accordingly, the step of setting a secured communication channel further comprising: configuring the virtual machine (VM) breach-detection proxy with a sub-domain and an associated certificate to provide a secured communication with the proxy; and distributing an identical set of encryption keys to at least one system user, at least one server and the proxy.

As appropriate, the step of retrieving a set raw log data information further comprising: interfacing with at least one user plugin associated with at least one system user.

As appropriate, the step of recording at least one user activity further comprising: recording at least one http packet when the secured communication channel is being established; and injecting a recording block of code into at least one http related page to allow tracking of the at least one system user activity.

As appropriate, the step of reconstructing the set of raw log data information and the recorded at least one user activity further comprising: indexing the video representation such that it is playable at a desired location.

According to yet another aspect of the presently disclosed subject matter, a resource protection system is disclosed, operable to perform resource access analysis to prevent breaching a sensitive organizational information stored in a cloud environment associated with a third-party provider, the resource protection system, comprising: a virtual machine (VM) breach-detection proxy operable to perform automated control of at least one system user using a communication device and accessing at least one data sensitive region stored in the cloud infrastructure environment with at least one login credential; a virtual machine (VM) breach-detection portal operable to provide system administration of at least one data sensitive region; and an identity access management module operable to control at least one login credential configured to allow authorized access to the at least one data sensitive region; wherein at least one system user is directed to access the cloud infrastructure environment via the virtual machine (VM) breach-detection proxy; and wherein the resource protection system is operable to provide identity access management and further control at least one login credential automatically.

As appropriate, the identity access management module is operable to enhance at least one login credential with a second login credential, the second login credential is selected from a group consisting of: randomizing at least one login credential, adding a facial recognition, adding a fingerprint, adding a biometrics and combinations thereof.

As appropriate, The resource protection system, wherein the virtual machine (VM) breach-detection proxy comprises the virtual machine (VM) breach-detection portal.

Additionally, the resource protection system, wherein the virtual machine (VM) breach-detection proxy is operable to support the transport layer security (TLS), to handle at least one http packet and to inject a recording code on way back to the client communication device.

### BRIEF DESCRIPTION OF THE DRAWINGS

For a better understanding of the embodiments and to show how it may be carried into effect, reference will now be made, purely by way of example, to the accompanying drawing figures.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIG. 1 is a schematic block diagram illustrating the main elements of a resource protection system distribution using a virtual machine (VM) breach-detection proxy, according to one embodiment of the current disclosure;

FIG. 2A is a schematic block diagram illustrating another possible resource protection system distribution, with a communication path of a system user's request when interacting with the cloud infrastructure environment via the virtual machine (VM) breach-detection proxy;

FIG. 2B is a schematic block diagram illustrating yet another possible resource protection system distribution, with the virtual machine (VM) breach-detection proxy positioned within the cloud infrastructure environment;

FIG. 3A is a schematic block diagram illustrating a possible resource protection system architecture, according to one embodiment of the current disclosure;

FIG. 3B is a schematic block diagram illustrating another possible resource protection system architecture, according to one embodiment of the current disclosure;

FIG. 3C is a schematic block diagram illustrating yet another possible resource protection system architecture, according to one embodiment of the current disclosure;

FIG. 4A is a flowchart representing selected actions illustrating a possible method configured for performing resource security analysis;

FIG. 4B is a flowchart representing selected actions illustrating a possible method configured for setting a secured communication channel with the cloud infrastructure environment;

FIG. 4C is a flowchart representing selected actions illustrating a possible method configured for recording at least one system user activity in the cloud infrastructure environment;

FIG. 5A is a flowchart representing selected actions illustrating a possible method configured for performing identity access and system user activities' management; and

FIG. 5B is a flowchart representing selected actions illustrating a possible method configured for performing identity access to a system user accessing into the organizational cloud infrastructure environment.

### DETAILED DESCRIPTION

As required, detailed embodiments of the invention are disclosed herein; however, it is to be understood that the disclosed embodiments are merely examples of the invention that may be embodied in various and alternative forms. The drawing figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the invention.

Accordingly, various embodiments may omit, substitute, or add various procedures or components as appropriate. For instance, it should be appreciated that the methods may be performed in an order different from described, and that various steps may be added, omitted or combined. In addition, aspects and components described with respect to certain embodiments may be combined in various other embodiments. It should also be appreciated that the systems, methods, devices, and software may individually or collectively be components of a larger system, wherein other procedures may take precedence over or otherwise modify their application.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

As appropriate, in various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally, or alternatively, the data processor may access a non-volatile storage, for example, a magnetic hard-disk, flash-drive, removable media or the like, for storing instructions and/or data.

Aspects of the present disclosure relate to organizational information resources, more specifically, to a resource protection system. In particular, the current disclosure provides a breach-detection system for preventing security breach of internal organizational resources by authorized system users.

### Terms & Terminology:

As used herein, a breach-detection, as referred to in this specification, is generally referred to a category of applications and security devices designed to detect an activity of malware inside a network after a breach has occurred.

As used herein, a virtual machine (VM), as referred to in this specification, is an operating system (OS) or an application environment installed on software, which emulates a dedicated hardware. The system user will have the same experience on a virtual machine as he/she would have on a dedicated hardware.

As used herein, identity access management, as referred to in this specification, is an administrative area dealing with identifying individuals in a system network and controlling their access to resources using a login credential, within that system by associating user rights and restrictions with the established identity.

As used herein, the term ‘cloud’ or the term ‘cloud environment’ refer to all cloud offerings and Infrastructure-as-a-Service (IaaS) as well as all software-as-a-service (SaaS) application.

As used herein, a cloud infrastructure environment, as referred to in this specification, is generally refereed to the hardware and software components, such as servers, storage, a network and virtualization software that are needed to support the computing requirements of a cloud computing environment. Such environment may also include a set of associated software applications to answer organisational needs. It is noted that a cloud infrastructure environment may additionally or alternatively include stand alone applications such as Software as a Service (SaaS) applications including but not limited to centrally hosted subscriptions services such as Salesforce®, Dropbox® or the like.

It is particularly noted that the cloud infrastructure environment may be associated with a third-party provider.

As used herein, infrastructure as a service (IaaS), as referred to in this specification, is a form of cloud computing that provides virtualized computing resources over the internet. Accordingly, a cloud provider may host the infrastructure components traditionally present in an on-premises data center, including servers, storage and networking hardware, as well as the virtualization or hypervisor layer. The IaaS provider may also supply a range of services/applications to accompany those infrastructure components. A user may access hosts via various satellite devices such as computers, notebooks, laptops tablets, mobile telephones, dedicated terminals and the like.

As used herein, Software as a Service (SaaS), as referred to in this specification relates to a form of cloud computing providing centrally hosted services for various applications including but not limited to office software, messaging software, payroll processing software, management software, computer aided design software, development software, accounting, customer management (CRM), Management Information Systems (MIS), enterprise resource planning (ERP), invoicing, human resource management (HRM), talent acquisition, content management (CM), service desk management and the like. SaaS may be accessed by multiple users various satellite devices such as computers, notebooks, laptops tablets, mobile telephones, dedicated terminals and the like, who may use SaaS for collaboration or individual use.

### General Aspects:

Data loss prevention and avoiding security breaches securing organizational assets and creates a great challenge. The protecting of critical organization data, for businesses of all sizes and across all sectors, specifically when stored in a cloud infrastructure environment, without disrupting productivity and system users' privacy, is essential and of great importance.

People often represent the weakest link in the security chain and are chronically responsible for the failure of security systems

Aspects of the present disclosure are associated with the cloud, as used herein the term ‘cloud’ refers to all cloud offerings and Infrastructure-as-a-Service (IaaS) as well as all software-as-a-service (SaaS) application. The present disclosure specifically relates to resource protection and identity access management system operable to verify that sensitive organizational information considered as an organization critical asset is securely stored in a remote cloud infrastructure environment, either private or public (external third-party resources). The suggested system's architecture further verifies that the organization critical information assets is kept secret and remains confidential with no data losses, providing full organizational control over its sensitive data.

Generally, with regard to network traffic, two types of proxies are known: a forward proxy and a reverse proxy and commonly they are positioned between the client and the server.

A forward proxy server is configured to regulate outbound traffic according to preset policies in a shared network, taking communications from the client and forwarding the communications to the server. The reverse proxy also serves as a gateway between users and application origin server and reverses the communications from the server to the client. Yet, the virtual machine (VM) breach-detection proxy is operable to handle all transport layer security (TLS) protocol communications, associated certificate, encryption keys and may also change the associated domain/sub-domain such that the communication traffic is directed via the breach-detection proxy. This may be looked upon as a “positive” man in the middle attack, to answer security needs of an organization.

### Identity Access Management:

Various attempts are suggested to solve security issues associated with cloud computing and storing of data in the cloud. Yet, the effort and suggested solutions are associated with attempts to external breaching and stealing of information, from the outside. The disclosure, as currently presented of the resource protection system, provides a combined, unique and versatile architecture to handle security incidents occurring from the inside and further provides identity access management, to prevent security breaches, coming also from external attacks. Thus, the current disclosure is operable to secure login credentials of a system user, such as an employee or a remote vendor, relating to all infrastructure and/or applications in the cloud environment, irrespective of the endpoint-communicating device from which the system user may log in.

It is specifically noted that the resource protection system is configured to operate with various accessing devices, such as personal computers, desktop devices, laptop computers, tablets, notebooks, mobile/portable devices and the like. Such devices may be operable by user to log into the organizational system from within the organization systems, or by connecting from the outside.

It is further noted that the system user may refer to a group of individuals including any internal employee, external employee, partner, customer, vendor, supplier and the like. Each such system user may have access pre-configured to specific areas determined by a system administrator, for example, finance, supply, orders and purchases, human resources, research and development and the like.

Unfortunately, it is a common practice that system users (employee, remote vendors and the like) protect businesses critical data using passwords as their security credential, and commonly apply a weak or easy to guess password. The applied password may include a pattern with an associated name, a family name, associated figures and the like. Such weak passwords or stolen passwords are one of the top causes of data breaches and the vast majority of attacks on corporate networks. Verizon, a leading communication technology company, estimates that about 80 percent of all data breaches may be avoided, if a stronger mechanism applied to provide a stronger password. Thus, the resource protection system configured to provide identity access management, aim is to make sure that its system user's login credentials are secured to enable protecting and keeping confidential the critical information assets of the organization stored in the cloud.

The identity access management of the resource protection system has a unique and versatile architecture. The software of the identity access management component automatically changes and improves system users' (employee, remote vendors and the like) login credentials, being protected, to a string of random values. The applied changes ensure that the login credentials are always strong and system user's security best practices are adhered to.

It is noted that the identity access management module is operable to enhance password credentials with biometrics and facial recognition associated with third-party cloud providers' normal password protections. For example, Salesforce provide a password and the identity access management module may add facial recognition for a system user at login.

Generally, a strong password is the first line of defense against external threats such as hackers and ensures a business's critical data to remain safe.

It is further noted that the suggested disclosure, in particular, the Identity Access Management software is agentless, secured, non-intrusive and may be deployed within minutes.

### System Visualization:

The software of the resource protection system is to provide session recordings and is operable to record the flow of work performed by a system user (employee/remote vendor, partner, customer, supplier and the like) associated with the organization's most sensitive and critical information stored in an associated cloud infrastructure environment and an associated set of applications. Accordingly, the resource protection system may be configured in parallel, to generate simple and easy mechanism to read data logs associated with the flow work of a system user with the sensitive data stored in the associated cloud infrastructure environment. These data logs may be indexed against the video-recorded sessions, thus, providing a simple and easy to use/read data logs and further allowing to quickly read and understand a dangerous activity of the system user regarding a critical data region. The video-recorded session as represented may be played from any point of interest without the need of watching the full video-recorded session representation, which may be very time consuming. The solution, as presented by the resource protection system is user friendly, easily operable even for those without security experience. One can now simply watch the video-recorded session and understand the activities occurring at a specific time/event to allow for remedial action, if necessary.

This unique approach is currently lacking in the tool box of security breach prevention systems of existing cloud tool sets.

The resource protection system performs recordings of system user activities only for those activities associated with sensitive/critical data regions, as configured by the resource protection system's administrator. The resource protection system is not aimed at spying over user personal activities while at work. Thus, no recording will take place of personal matters such as internet browsing, social network activities as Facebook, Google+ and the like. The purpose of resource protection system is to enable businesses to protect their most critical information, being hosted by a third-party provider, and not to monitor employee performance.

It is noted that the session video recordings, as part of the resource protection system adhere to the most stringent of privacy regulation and meet the requirements of countries such as Germany, UK, Australia and the US.

One of the risks associated with cloud computing and storage is the likelihood of data loss in various aspects. With the resource protection system applied to organization data resources, this risk may be prevented or at least be reduced significantly. The fact that system users (employees/partner, vendors and the like) know that they are being recorded, and may be held fully accountable for their actions, prevents data loss much the same way as a speed camera prevents drivers from speeding. The resource protection system allows small/medium businesses and corporate enterprises to easily meet their security and compliance requirements.

The resource protection system easily integrates with all known cloud offerings, private-cloud environments and public-cloud environments such as Amazon® cloud Web Services, Google®, Microsoft® and IBM® and other dedicated applications such as Salesforce®, Microsoft office 365, Google Apps, SAP and the like. The resource protection system is known to be the only tool providing such a wide and comprehensive coverage of all third-party providers hosting businesses most critical information.

Furthermore, the resource protection system may be configured to easily integrate with Security Information and Event Management (SIEM) systems, Monitoring Tools, User Behavior Analytics software, additional Identity and Access Management tools to give businesses much greater visibility into their security than what is currently on offer.

The resource protection system software is agentless, secure, non-intrusive and can be deployed in a short time, within minutes.

### System Architecture/Technology:

The resource protection system is operable to perform resource access analysis to prevent breaching sensitive organizational information stored in a cloud infrastructure environment. The system architecture of the resource protection software includes a virtual machine (VM) breach-detection proxy, a virtual machine (VM) breach-detection portal. Additionally, the resource protection system may include a user plugin module operable to communicate with the system user plugin. Furthermore, the resource protection system may include an identity access management module.

It is noted that the virtual machine (VM) breach-detection proxy may include the virtual machine (VM) breach-detection portal forming a single virtual machine (VM) component.

The virtual machine (VM) breach-detection proxy is operable to perform automated control and monitoring of at least one activity of at least one system user accessing at least one data sensitive region. The virtual machine (VM) breach-detection portal may be operable to provide system administration to at least one data sensitive region. The user plugin module is operable to retrieve user data associated with at least one system user via an associated user plugin.

Additionally, the resource protection software is operable to interface with the cloud infrastructure environment and/or cloud software applications such as Office 365, salesforce.com and the like to retrieve log files associated with the at least one system user. As appropriate, the resource protection system is further operable to provide video session recording to allow visibility of system user activities accessing a data sensitive region in the cloud infrastructure environment associated with sensitive organizational information.

### System Setup:

Initial system setup requires loading the system's virtual machine components, which may include a virtual machine (VM) breach-detection proxy operable to communicate with the cloud infrastructure environment and a virtual machine (VM) breach-detection portal operable to provide system administration. The system's virtual machine (VM) components are automatically installed upon loading.

It is noted that the virtual machine (VM) breach-detection proxy may include the virtual machine (VM) breach-detection portal forming a single virtual machine (VM) component.

Upon initial install, the system administration may log into the system via the virtual machine (VM) breach-detection portal to determine the organization sensitive regions and may further configure the cloud environment, and apply the associated protected measures to allow actual work to be performed.

Additionally, or alternatively, the system administrator may log into the breach-detection portal to configure the desired cloud infrastructure environment that may be configured to manage the identity of the employees and may further select all employees that will go through the identity system.

The system administrator may also select the identity type applied to an employee, such as username/password, one-time password (OTP), fingerprint, face recognition and the like.

### System Work Flow:

Generally, the resource protection system is operable to use plugins to retrieve the necessary information that may enable the system administrator of the resource protection system to select target employees for monitoring and recording, such that their activities may be tracked.

The resource protection system may integrate via the Application Programming Interfaces (APIs) of various cloud infrastructure and/or cloud applications configured to be active in the cloud infrastructure environment. This integration allows the resource protection system to retrieve the associated system users (employees, remote vendors, suppliers, partners and the like) log files from the organizational cloud infrastructure (private or external). All operations and data taken from the log files may be indexed and saved in a data repository.

It is specifically noted that all company employees can only access the cloud infrastructure environment through the resource protection system virtual machine proxy. The resource protection system may be operable to configure the cloud infrastructure environment to accept communication requests only from the resource protection system virtual machine (VM) proxy.

The virtual machine (VM) proxy is operable to save, merge, and re-indexes all communication pages and operations on the page with the logs may be saved in a data repository. Thus the resource protection system is operable to register a sub domain for the breach-detection proxy and further may configure the breach-detection proxy with that sub domain. Consequently, all organization employees will use a new domain to communicate with the cloud infrastructure and/or applications.

Additionally, the resource protection system may get a correct certificate for the breach-detection proxy sub domain and further configure the breach-detection proxy with that certificate. This will establish a secured communication channel from each communication device used by an employee to the breach-detection proxy. Additionally, the resource protection system may handle the Transfer Layer Security (TLS) protocol and to verify that each system component client's communication device, infrastructure server and breach-detection proxy have the same (identical) set of encryption keys. The breach-detection proxy may further operable to handle all TLS protocol aspects to get a secured channel between the client communication device and the infrastructure server going through the breach-detection proxy. When this secured channel is established the breach-detection proxy may start tracking and recording all HTTP packets.

Furthermore, the resource protection system may handle the HTTP protocol and verify that all communication requests are directed through the breach-detection proxy and all HTTP packets are recorded. The breach-detection proxy will further verify that the HTTP packets are correctly formatted such that all packets are always directed through the proxy. All HTTP packets directed through the proxy may be changed to verify that all following HTTP packets will also be directed through the breach-detection proxy.

It is noted that the resource protection system may also handle the HTML, CSS (cascade style sheets), JavaScript (all application source files) and inject a recording code configured to enable recording the system user activities on a page. These pages may be changed and a record code is added. This recording code may enable recording of the mouse and keyboard movements and clicks.

Optionally, storing of the log files and indexes is performed on a remote database associated with the breach-detection proxy server.

It is also noted that the resource protection system is operable to create a movie/representation from the recorded pages combined with the data stored in associated log files.

The information from the breach-detection proxy (all pages) and the information from the plugins (the log files) may be combined to create indexed movies/representations.

In a different work flow scenario, when an employee is being selected by the system administrator, his credentials in all cloud services (including the associated set of software applications) may be changed and set with a random value. This new credential may serve from this point as the entry code into the cloud infrastructure environment and managed by the resource protection system.

Similarly, all cloud infrastructure environments are also configured to accept access only from the breach-detection proxy. Thus, when a system user wants to access the cloud infrastructure environment, he/she will have to go through the proxy using the relevant sub-domain.

Accordingly, as the breach-detection proxy will obtain the system user request to login to a service, it will send the system user an identity request. If the user identity is being verified, the breach-detection proxy will redirect the correct credentials to the service and the system user may gain access to the desired service.

In the same manner, a sub-domain may be registered for the breach-detection proxy and further configured the proxy with that sub-domain. All employees will now have a different domain to access the cloud environment. Additionally, an appropriate new certificate is obtained for the breach-detection proxy sub-domain and upon configuration of the certificate, all employees may use the secured channel to the breach-detection proxy.

Moreover, the breach-detection proxy is capable to handle the Transfer Layer Security (TLS) protocol and verify client, server and proxy have the same set of encryption keys. The breach-detection proxy will handle all TLS protocol aspects to obtain a secured channel between the system user communication device and the infrastructure server going throw the breach-detection proxy. When this secured channel is established the breach-detection proxy can send the identity request to the system user communication device.

Accordingly, the breach-detection proxy is operable now to handle the HTTP protocol and verify all requests are going throw the breach-detection proxy. Further, the breach-detection proxy will verify that the HTTP packets are correctly formatted such that they always go through the breach-detection proxy. All HTTP packets going through the breach-detection proxy are changed to validate that the next HTTP packets will also go throw the breach-detection proxy.

Generally, when entering a website, it is common to start via a login page. After login, the website may redirect the request to the actual website where all associated data is being stored. Furthermore, websites may provide services supporting a third-party identity service. A third-party identity service may be configured in one's service; this means that each time somebody will try to enter the website, the third-party login page will be displayed. A successful login is then redirected to the actual website.

It is noted that the suggested system is operable to provide support for the third-party identity protected services. The proxy may provide the identity access management service. All logins will go to the identity access management service and will be recorded. After a successful login the website will be redirected and the proxy will start recording the redirected site.

Optionally, if the protected service does not support the third-party identity service, the proxy may be configured to record the login session and the redirected website.

### DESCRIPTION OF THE EMBODIMENTS

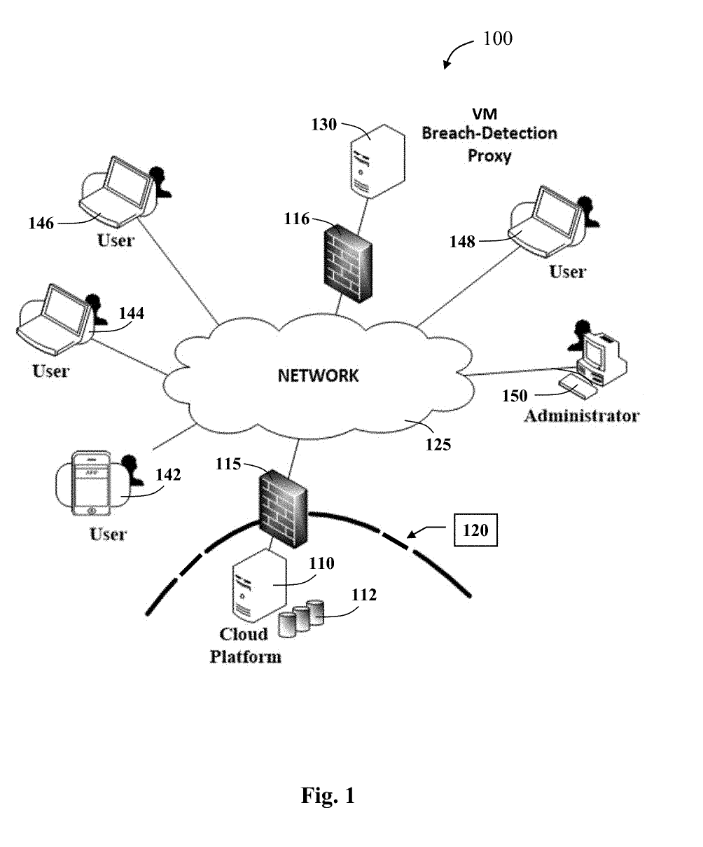

Reference is now made to FIG. 1, there is provided a general schematic block diagram representing a possible resource protection system distribution, which is generally indicated at 100, for performing security analysis, using a virtual machine (VM) breach-detection proxy, according to one embodiment of the current disclosure. The resource protection system distribution 100 consists of a virtual machine (VM) breach-detection proxy 130 loaded onto a server machine, possibly behind a firewall system 116, and a virtual machine (VM) portal (not shown). The breach-detection proxy 130 is operable to perform automated control and monitoring at least one activity of a system user using a communication device such as tablet 142, laptop computers 144, 146 and 148, for example, accessing at least one data sensitive region. The virtual machine proxy 130 is in communication, via the external network 125, with a cloud infrastructure environment 120. The cloud infrastructure environment 120 may include a central server 110, possibly behind a firewall system 115, a data repository 112 and a set of associated applications (not shown).

The administrator 150 is operable to configure the resources protection system, determine data sensitive regions of the organizations system(s), regions that needs monitoring, system users to for monitoring and responsible of identity access aspects management.

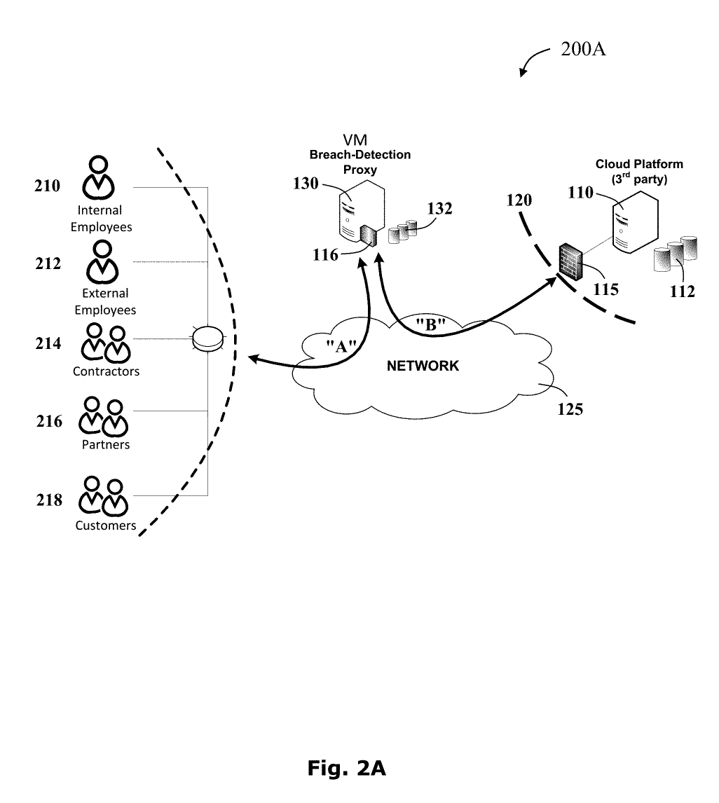

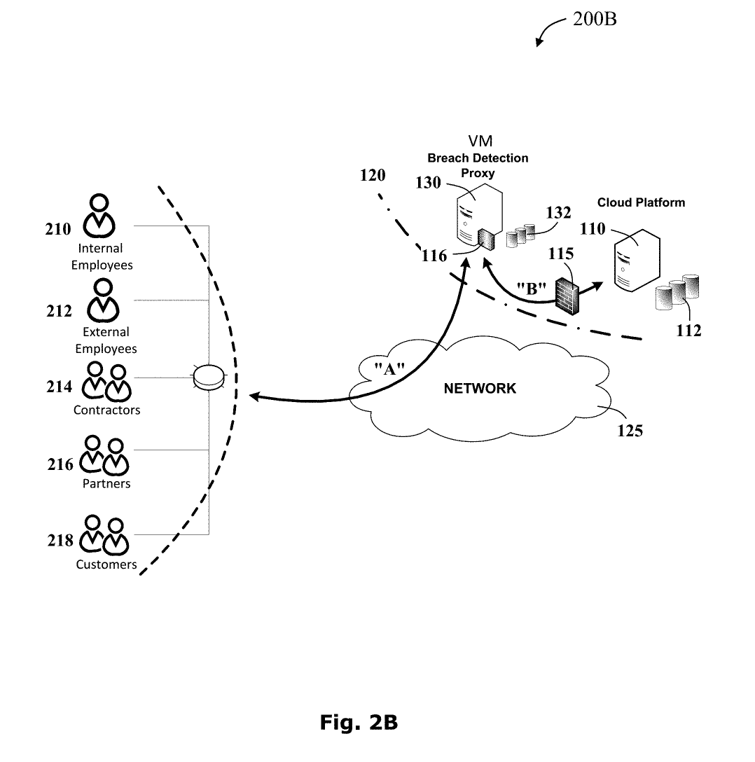

Reference is now made to FIG. 2A, there is provided a general schematic block diagram representing another possible resource protection system distribution, which is generally indicated at 200A, providing an indication of the communication path of a system user request when interacting. The resource protection system distribution 200A may be associated externally with the cloud 120 via the virtual machine (VM) breach-detection proxy 130, according to one embodiment of the current disclosure.

A system user, may be one of a group consisting of: an internal employee 210, an external employee 212, a contractor 214, a partner 216, and a customer 218. Each time a system user is communicating using his/her own dedicated communicating device, with the cloud infrastructure environment 120, the communication is automatically directed towards the virtual machine (VM) breach-detection proxy 130 (path “A”), using a registered sub-domain and an associated certificate providing a secured channel between the personal device and the proxy. The breach-detection proxy, further directs the user communications to the cloud infrastructure environment 120 (path “B”, via Server 110/any of the associated cloud set of applications).

It is noted that communication channel between the system user device and the cloud infrastructure environment is a secured communication channel for all communications. The first indicated path “A” is secured by using a registered dedicated common sub-domain and an associated certificate. The second indicated path “B” is a secured communication channel comprising an identical set of encryption keys for the communicating device, the breach-detection proxy and the cloud infrastructure environment achieved by handling all transport layer security (TLS) protocol communications by the virtual machine (VM) breach-detection proxy. It is particularly noted that the current disclosure is uniquely adding a recording code to http packets on the way back to the client.

It is noted that cloud infrastructure environment 120 may be associated with a third-party provider such as Amazon Web Services (AWS) and the like.

Reference is now made to FIG. 2B, there is provided a general schematic block diagram representing yet another possible resource protection system distribution 200B n in which the cloud platform 110 is not necessarily a third party platform. The block diagram indicates the communication path of a system user request when interacting with an internal cloud platform 110 via an internal proxy 130. The resource protection system distribution 200B shows the virtual machine (VM) breach-detection proxy 130 positioned within the cloud infrastructure environment 120, according to another embodiment of the current disclosure.

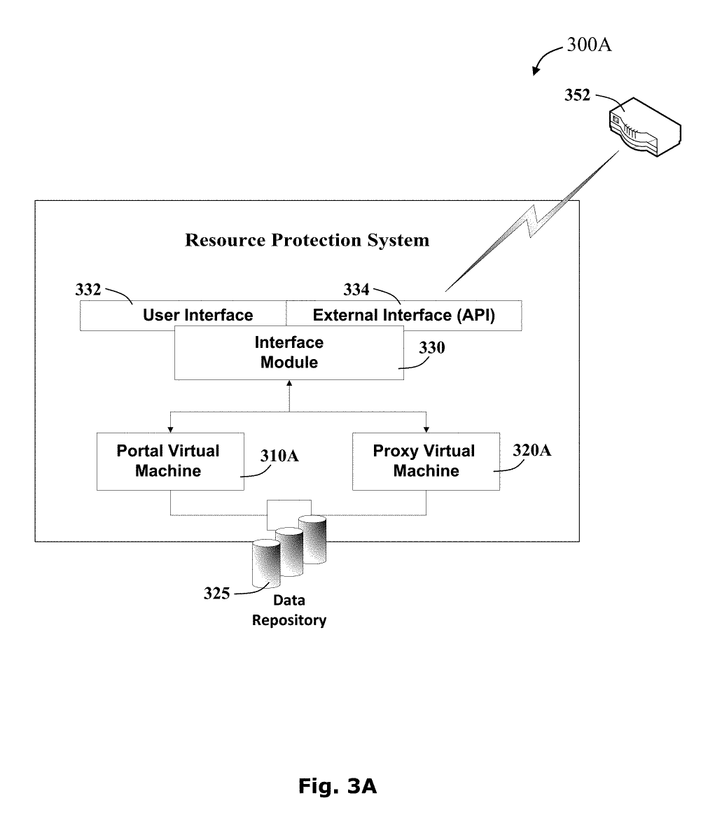

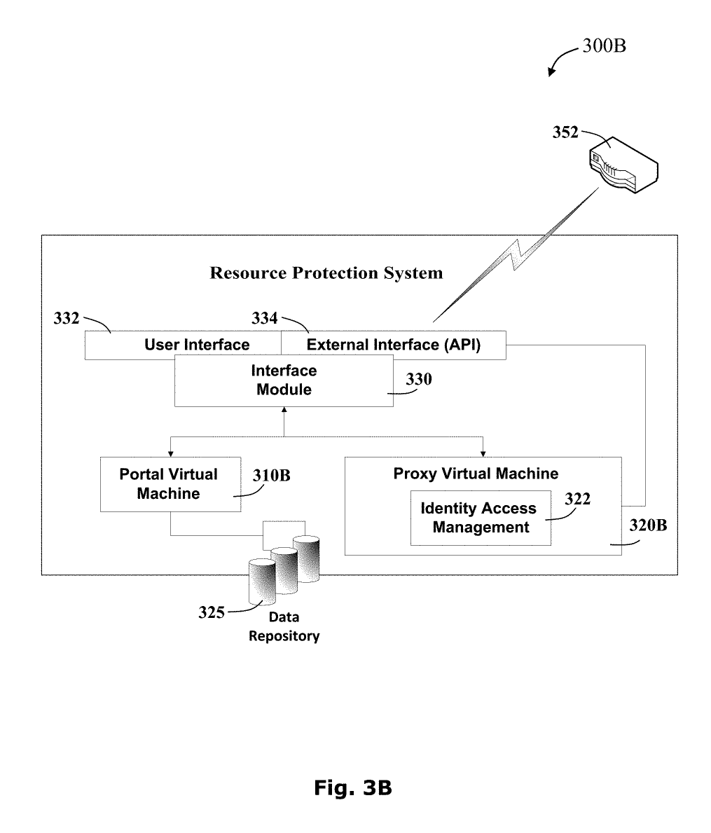

Reference is now made to FIG. 3A, there is provided a general schematic block diagram representing a possible resource protection system architecture, which is generally indicated at 300A, according to one embodiment of the current disclosure. The resource protection system architecture 300A, consists of a virtual machine (VM) portal 310A operable to provide system administration for at least one data sensitive region via a virtual machine (VM) breach-detection proxy 320A operable to perform automated control and monitoring of at least one activity of a system user. The system user may be using a communicating device accessing at least one data sensitive region and a data repository 325. The resource protection system 300A is further accessible via an appropriate interface module 330, enabling communications from system user to reach the desired target in the cloud infrastructure environment via the configuration of the virtual machine breach-detection proxy (item 130, FIG. 1).

It is noted that, prior to sending communications from the breach-detection proxy to the client communication device 352, the communication data received by the breach-detection proxy may be manipulated. For example, injecting a recording code into an application page to enable user activity tracking, changing login credential of a system user into a stronger credential to improve system's security and the like.

It is further noted that each of the virtual machines (VM), the portal virtual machine 310A and the proxy virtual machine 320A are automatically installed upon loading.

Reference is now made to FIG. 3B, there is provided a general schematic block diagram representing another possible resource protection system architecture, which is generally indicated at 300B, according to one embodiment of the current disclosure. The resource protection system architecture 300B, consists of a virtual machine (VM) portal 310B operable to provide system administration of at least one data sensitive region. Further, the system includes a virtual machine (VM) breach-detection proxy 320B operable to perform automated control and monitoring of at least one activity of a system user using a communicating device accessing at least one data sensitive region and a data repository 325. The virtual machine (VM) breach-detection proxy 320B further comprises an identity access management module 322 operable to control automatically an initial login credential associated with the one system user configured to allow initial authorized access to at least one data sensitive region. The identity access management module 322 may further provide a stronger identity for a system user by replacing the initial login credential with a second login credential, comprising a random value. Additionally, or alternatively the stronger identity login credential may serve as the entry code to the cloud environment.

It is noted that the initial login credential of the system user may be selected from at least one of a group consisting of: a user name and password, one-time password (OTP), a fingerprint, a face recognition or combinations thereof.

Reference is now made to FIG. 3C, there is provided a general schematic block diagram representing yet another possible resource protection system architecture, which is generally indicated at 300C, according to one embodiment of the current disclosure. The resource protection system architecture 300C consists of a virtual machine (VM) portal 310C operable to provide system administration of at least one data sensitive region. The system architecture 300C further includes and a virtual machine (VM) breach-detection proxy 320C operable to perform automated control and monitoring of at least one activity of a system user, using a communicating device accessing at least one data sensitive region and a data repository 325. The virtual machine (VM) breach-detection proxy 320C, further comprises: an identity access management module 324C operable to control and manage automatically an initial login credential, as described herein above. Additionally, a recording module 328C is operable to record at least one user activity and also recording at least one http packet when the secured communication channel being established and index generating module operable generate appropriate indexing to a video representation such that it is playable at a desired location. It is noted that recording may include injecting a recording code into an http packet communicated towards the client communication device.

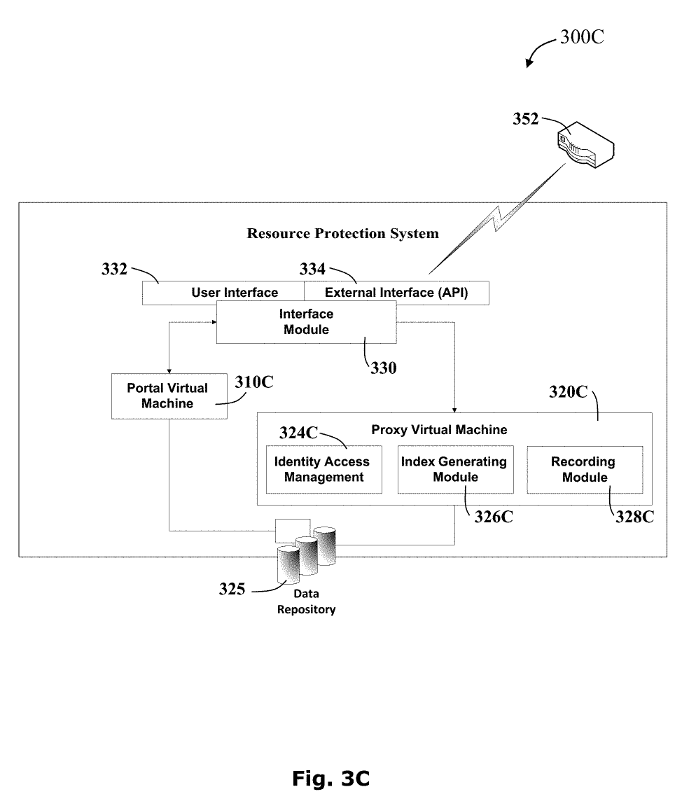

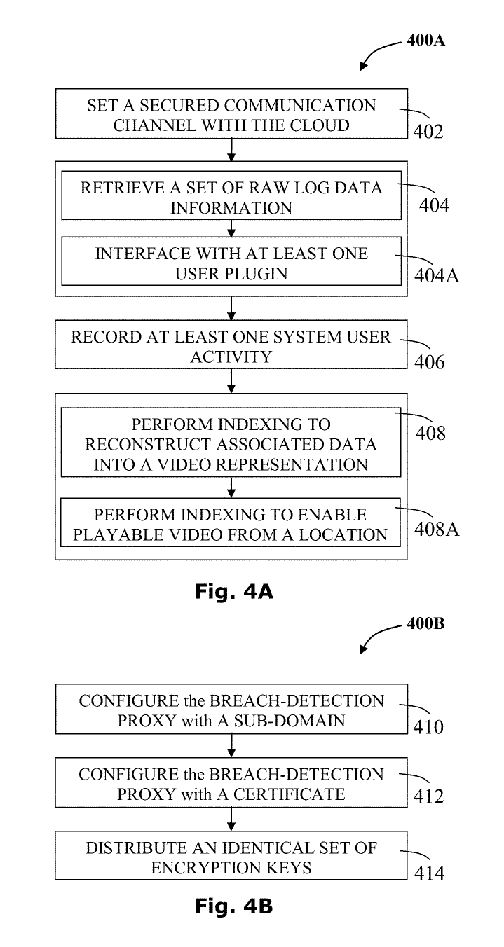

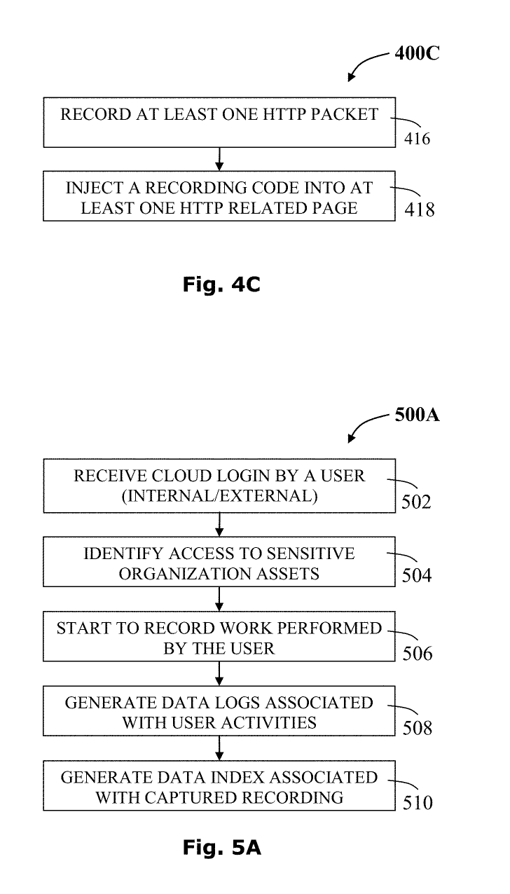

Reference is now made to FIG. 4A, there is provided a flowchart representing selected actions illustrating a possible method configured for use in a resource protection system, which is generally indicated at 400A, for performing resource security analysis. The method 400A covers an exemplified business usage of controlling and managing organizational resources associated with a system user, having authorized access to data sensitive regions.

The method 400A may be triggered by a system administrator, executing a software application loaded and installed as a virtual machine (VM) breach-detection proxy via an associated virtual machine (VM) portal, and includes the following steps:

In step 402—setting a secured communication channel with the cloud infrastructure environment, thus providing secured communication for each system user with the organizational software applications. It is noted that the setting of a secured channel, implies a secured path between the communication device of the system user onto the proxy, and further a secure path for the communications between the proxy and the cloud;

In step 404—retrieving a set of raw log data information associated with at least one system user from the cloud infrastructure server and/or applications, mainly in the form of log files in various data formats. It is noted that all raw log files may be synchronized with the company's information systems, thus providing a global view over the organization sensitive regions. Optionally, the step, may further include step 404A—interface with at least one user plugin associated with the at least one system user;

In step 406—recording at least one user activity, performed automatically based upon associated configuration as may be determined by the system administrator; and

In step 408—reconstructing the set of raw log data information and the recorded data of at least one user activity into a video representation. Optionally, the step, may further include step 408A—perform indexing of the video representation such that it is playable at a desired location.

It is noted that the resource protection system may be integrated with other organization systems, to get a better overview for an improved security analysis.

Reference is now made to FIG. 4B, there is provided a flowchart representing selected actions illustrating a possible method configured for use in a resource protection system, which is generally indicated at 400B, for setting a secured communication channel with the cloud infrastructure environment. The method 400B covers the path of having a security channel between the system user device and the virtual machine detection proxy and onwards to the cloud infrastructure environment.

The method 400B may be triggered as a first step, prior applying protection procedures, by a system administrator, and includes the following steps:

In step 410—configuring the breach-detection proxy with a registered sub-domain;

In step 412—configuring the sub-domain associated with the breach-detection proxy with an appropriate security certificate to provide a secured path between the system user and the virtual machine breach-detection proxy; and

In step 414—distributing an identical set of encryption keys to at least one system user communication device, the cloud infrastructure server and the breach-detection proxy, to provide a secured path between the proxy and the cloud infrastructure environment.

Reference is now made to FIG. 4C, there is provided a flowchart representing selected actions illustrating a possible method configured for use in a resource protection system, which is generally indicated at 400C, for recording at least one system user activity in the cloud infrastructure environment. The method 400C may be triggered only after the security channel of step 402 has been established, by a system administrator, and includes the following steps:

In step 416—recording at least one http packet when the secured communication channel being established; and

In step 418—injecting a recording block of code into at least one http related page to allow tracking of at least one system user's activities.

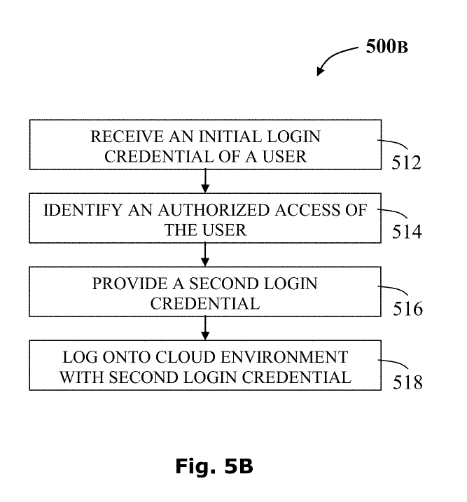

Reference is now made to FIG. 5A, there is provided a flowchart representing selected actions illustrating a possible method configured for use in a resource protection system, which is generally indicated at 500A, for performing identity access and system user activities' management. The method 500A covers access into the organizational cloud infrastructure environment via the virtual machine detection proxy.

The method 500A may be triggered only after the security channel has been established, and includes the following steps:

In step 502—receiving a cloud infrastructure environment (internal/external) login request, via the virtual machine (VM) breach-detection proxy;

In step 504—identifying access of a system user into a sensitive organizational region;

In step 506—starting of recording the various work activities of the system user in at least one sensitive region;

In step 508—generating relevant data logs associated with the system user work activities; and

In step 510—generate data index associated with the captured recording of the system users' work activities.

Reference is now made to FIG. 5B, there is provided a flowchart representing selected actions illustrating a possible method configured for use in a resource protection system, which is generally indicated at 500B, for performing identity access of a system user accessing the organizational cloud infrastructure environment. The method 500B may be triggered only after the security channel has been established, and includes the following steps:

In step 512—receiving a login request into the cloud infrastructure environment with an initial login credential of a system user;

In step 514—identifying an authorized access of a system, using an initial login credential;

In step 516—providing a second login credential to replace the initial login credential for further access into the cloud infrastructure environment, wherein the second login credential is stronger compare with the initial login credential, say, by adding randomly generated numbers; and

In step 518—performing a login into the cloud infrastructure environment using the second login credential, previously generated.

### Notes and Comments:

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as communicating unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

The scope of the disclosed subject matter is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed is:

1. A resource protection system operable to perform resource access analysis to prevent breaching sensitive organizational information stored in a cloud environment, said resource protection system, comprising:
a virtual machine (VM) breach-detection proxy operable to perform automated control and monitoring of at least one activity of at least one system user using a communication device and accessing at least one data sensitive region; and
a virtual machine (VM) breach-detection portal operable to provide system administration of the at least one data sensitive region;
wherein said resource protection system is operable to interface with the cloud environment to retrieve at least one log file associated with the at least one system user, and
wherein said resource protection system is operable to provide at least one video session indexed representation to allow visibility of the at least one system user activity accessing said at least one data sensitive region, said indexed representation uses the at least one log file.

2. The resource protection system of claim 1, wherein said virtual machine (VM) breach-detection proxy is operable to provide a secured communication channel for all communications between the communicating device and the cloud environment via said virtual machine (VM) breach-detection proxy.

3. The resource protection system of claim 2, wherein said secured communication channel comprises using a dedicated sub-domain and an associated security certificate, such that the at least one system user can communicate securely via the communicating device with the virtual machine (VM) breach-detection proxy.

4. The resource protection system of claim 2, wherein said secured communication channel further comprising an identical set of encryption keys for the communication device, the breach-detection proxy and the cloud environment achieved by handling all transport layer security (TLS) protocol communications by the virtual machine (VM) breach-detection proxy.

5. The resource protection system of claim 1, wherein said virtual machine (VM) breach-detection proxy is operable to inject a recording code into at least one application page received by communication device to allow recording and tracking at least one system user activity.

6. The resource protection system of claim 1, wherein said virtual machine (VM) breach-detection proxy comprises a user plugin module, said user plugin module is operable to execute instructions and communicate with at least one system user plugin associated with the at least one system user via a dedicated API (Application Programming Interface).

7. The resource protection system of claim 6, wherein said user plugin module is operable to enable selecting at least one system user for generating at least one video session indexed representation.

8. The resource protection system of claim 1, wherein said virtual machine (VM) breach-detection proxy comprises an identity access management module to control automatically an initial login credential associated with the at least one system user, said initial login credential is configured to allow initial authorized access to at least one data sensitive region.

9. The resource protection system of claim 8, wherein said initial login credential is selected from at least one of a group consisting of: a user name and password, one-time password (OTP), a fingerprint, a face recognition, biometrics or combinations thereof.

10. The resource protection system of claim 8, wherein said identity access management module is operable to change the initial login credential with a second login credential comprising a random value.

11. The resource protection system of claim 10, wherein said second login credential serves as the entry code to the cloud environment.

12. The resource protection system of claim 8, wherein said identity access management module is operable in a non-intrusive manner.

13. The resource protection system of claim 2, wherein said virtual machine (VM) breach-detection Proxy is configured to record at least one http packet when the secured communication channel is being established.

14. The resource protection system of claim 1, is further operable to configure the cloud environment to direct communication traffic via said virtual machine (VM) breach-detection Proxy.

15. A method for use in a resource protection system to perform resource security analysis in an improved manner,
said system comprises a virtual machine (VM) breach-detection proxy in communication with a cloud environment comprising at least one cloud server and a set of cloud infrastructures or cloud applications accessible to at least one system user using a communicating device, and a virtual machine (VM) breach-detection portal, said method comprising the steps of:
setting a secured communication channel with a cloud environment;
retrieving a set of raw log data information associated with at least one system user from said at least one cloud server;
recording at least one system user activity; and
reconstructing the set of raw log data information and the recorded at least one user activity into a video representation session.

16. The method of claim 15, wherein the step of setting a secured communication channel further comprising:
configuring the virtual machine (VM) breach-detection proxy with a sub-domain and an associated certificate to provide a secured communication with the proxy; and
distributing an identical set of encryption keys to the at least one system user, the at least one server and the proxy.

17. The method of claim 15, wherein the step of retrieving a set raw log data information further comprising:
interfacing with at least one user plugin associated with the at least one system user.

18. The method of claim 15, wherein the step of recording at least one user activity further comprising:
recording at least one http packet when the secured communication channel is being established; and
injecting a recording block of code into at least one http related page to allow tracking of the at least one system user activity.

19. The method of claim 15, wherein the step of reconstructing the set of raw log data information and the recorded at least one user activity further comprising:
indexing the video representation such that it is playable at a desired location.

20. A resource protection system operable to perform resource access analysis to prevent breaching a sensitive organizational information stored in a cloud environment associated with a third-party provider, said resource protection system, comprising:
a virtual machine (VM) breach-detection proxy operable to perform automated control of at least one system user using a communication device and accessing at least one data sensitive region stored in the cloud environment with at least one login credential;
a virtual machine (VM) breach-detection portal operable to provide system administration of the at least one data sensitive region; and
an identity access management module operable to control at least one login credential configured to allow authorized access to at least one data sensitive region;
wherein at least one system user is directed to access said cloud environment via said virtual machine (VM) breach-detection proxy; and
wherein said resource protection system is operable to provide identity access management and further control the at least one login credential automatically.

21. The resource protection system of claim 20, wherein said identity access management module is operable to enhance the at least one login credential with a second login credential, said second login credential is selected from a group consisting of: randomizing the at least one login credential, adding a facial recognition, adding a fingerprint, adding a biometrics and combinations thereof.

22. The resource protection system of claim 20, wherein said virtual machine (VM) breach-detection proxy is operable to support the transport layer security (TLS), to handle at least one http packet and to inject a recording code on way back to the communication device.
